(19) United States
(12) Patent Application Publication
(10) Pub. No.: US 2006/0027998 A1
(43) Pub. Date: Feb. 9, 2006

(54) Trailer hitch attachment

(76) Inventor: Gary S. Lewis, London (CA)

Correspondence Address: DARYL W SCHNURR;MILLER THOMSON LLP, PO BOX 578, SUITE 700, 22 FREDERICK STREET, KITCHENER, ON, N2G 4A2, CA

(21) Appl. No.: 10/912,203

(22) Filed: Aug. 6, 2004

(51) Int. Cl. B60D 1/06

(52) U.S. Cl. 280/511

(57) ABSTRACT

A trailer hitch attachment has an elevation adjuster to move elongated members that extend horizontally toward a rear of the attachment between a supporting surface and a trailer hitch of a motor vehicle. When articles are too heavy to lift on to the attachment, the attachment if lowered. The articles are then placed in the attachment and the attachment is raised. The articles are held in place on the elongated members. If desired, the distance between the elongated members is adjusted outward or inward to better accommodate the article being transported.

### BACKGROUND OF THE INVENTION

1. Field of the Invention

This invention relates to a trailer hitch attachment for use with a trailer hitch of a motor vehicle on a supporting surface wherein the attachment has an elevation adjuster to allow the attachment to be moved between a supporting surface and a level near the trailer hitch. This invention further relates to a method of operation of the trailer hitch attachment to transport articles using said attachment and the motor vehicle.

2. Description of the Prior Art

Trailer hitches are commonly used on motor vehicles to connect a trailer to the motor vehicle. A trailer can be designed to support various articles, including boats, snowmobiles, jet skiis, motorcycles and various other articles. The trailers are often designed to transport one article. Other articles cannot be transported using the trailer hitch as a user has only one trailer and that trailer is already fully utilized by the one article that the trailer is designed to transport. For example, a boat trailer has a boat mounted thereon. When the boat is mounted on the trailer, the trailer hitch cannot be used for any other purpose other than transporting the boat and boat trailer. When the boat and boat trailer are removed from that trailer hitch, unless the user has another trailer, the trailer hitch cannot be utilized to transport articles. Sometimes, articles to be transported are too heavy for a user to lift onto the trailer. Trailers are expensive and they can also be cumbersome making the motor vehicle more difficult to manoeuvre.

### SUMMARY OF THE INVENTION

It is an object of the present invention to provide a trailer hitch attachment that can be used in place of a trailer to transport articles. It is a further object of the present invention to provide a trailer hitch attachment that has an elevation adjuster thereon to move the attachment between the ground and a level that is at or near a level of the trailer hitch so that the motor vehicle can be driven without any possibility of the attachment contacting the ground

A trailer hitch attachment is used with a trailer hitch of a motor vehicle located on a supporting surface. The attachment comprises a base with an elevation adjuster extending upward therefrom. The elevation adjuster has a connector at a front thereof to removably connect the attachment to the trailer hitch. The base has two sides with elongated members thereon, there being one elongated member on each side. The elongated members extend rearward beyond the base. The elongated members each have a free end with a cross member extending between the elongated members at or near each free end. The elevation adjuster is constructed to move the elongated members vertically between the supporting surface and a level sufficiently clear of the supporting surface to enable the motor vehicle to be driven when the attachment is connected to the hitch.

A method of transporting articles uses a trailer hitch attachment for a trailer hitch of a motor vehicle. The attachment has a base with an elevation adjuster extending upward therefrom, the elevation adjuster having a connector at a front thereof to removably connect said attachment to said trailer hitch. The base has two sides with elongated members thereon, there being one elongated member on each side, the elongated members extending rearward beyond the base. The elongated members each have a free end with a cross member extending between the elongated members at or near the free end. The method comprises attaching the attachment to the trailer hitch, adjusting a distance between the elongated members, operating the elevation adjuster to lower the elongated members, placing an article to be transported on the elongated members, securing the article on the attachment, adjusting the elevation adjuster to raise the elongated members and the articles sufficiently above the supporting surface to allow the motor vehicle to be operated and securing the elongated members in position.

### BRIEF DESCRIPTION OF THE DRAWINGS

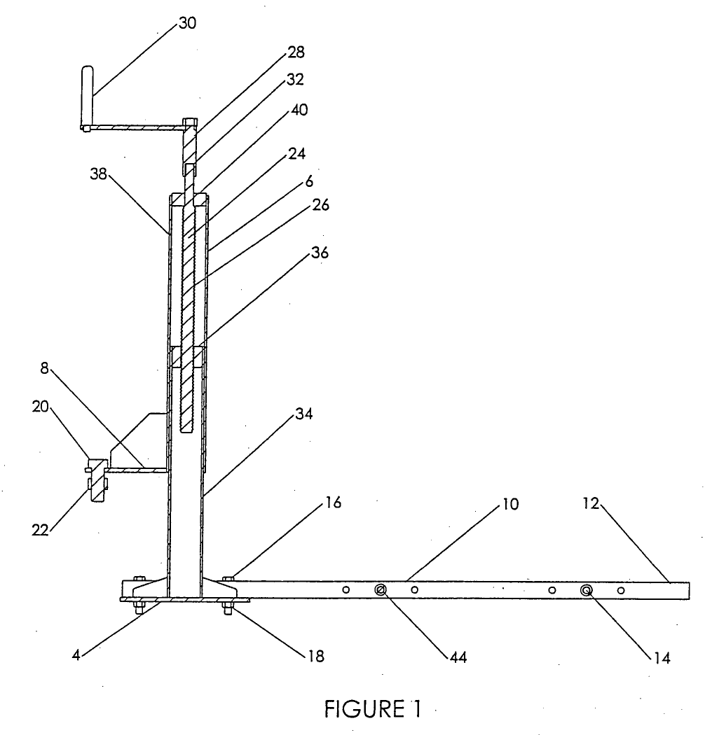

In FIG. 1, there is shown a sectional sideview of a trailer hitch attachment;

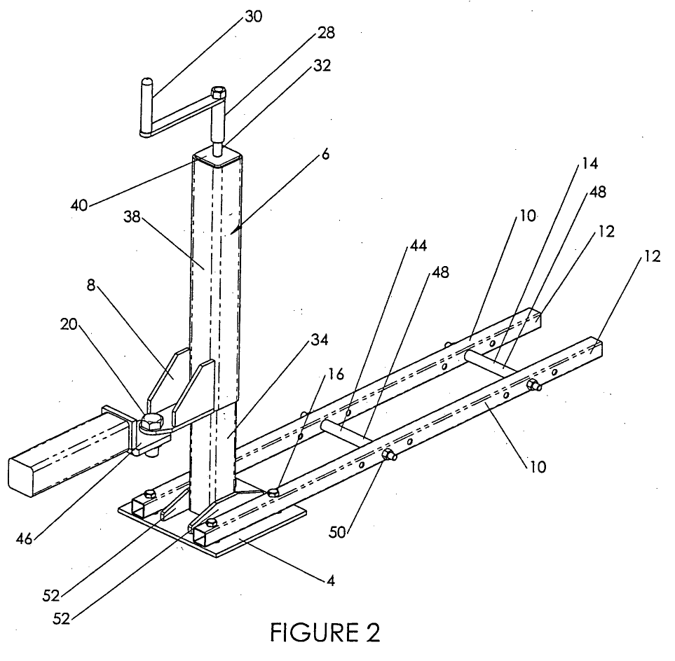

In FIG. 2, there is shown a perspective view of the trailer hitch attachment attached to a trailer hitch;

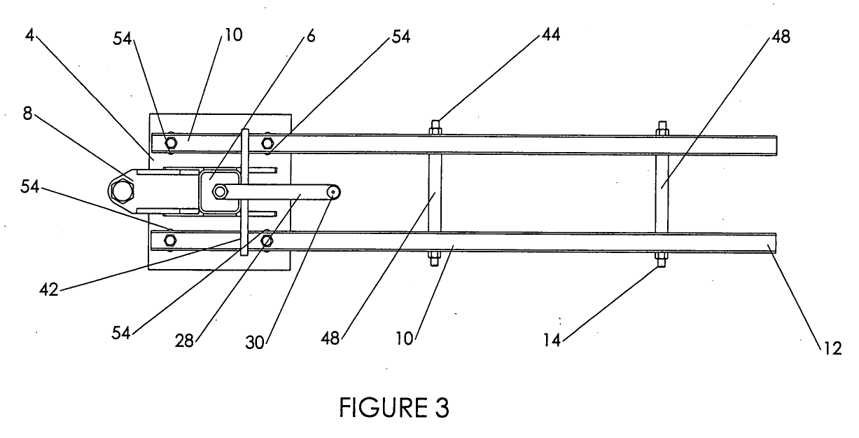

In FIG. 3, there is shown a top view of the trailer hitch attachment; and

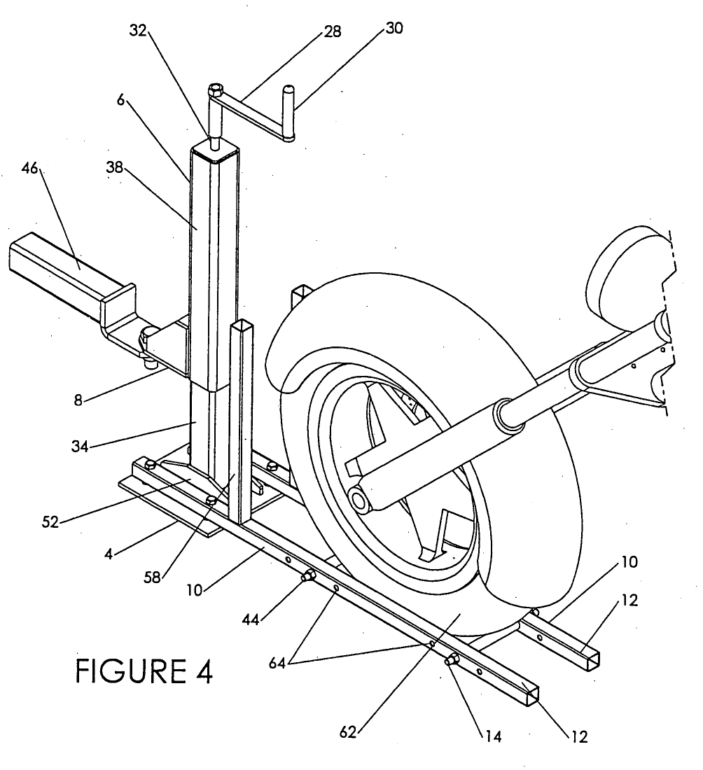

In FIG. 4, there is shown a perspective view of the further embodiment of the trailer hitch attachment.

In FIG. 1, a trailer hitch attachment 2 has a base 4 with an elevation adjuster 6 extending upward therefrom. The elevation adjuster 6 has a connector 8 on a front thereof to removably connect the attachment 2 to a trailer hitch (not shown in FIG. 1). The base 4 has two sides with elongated members 10 mounted thereon. The elongated members 10 extend rearward beyond the base 4 away from the trailer hitch. The elongated members 10 each have a free end 12 with a crossmember 14 extending between the elongated members 10 at or near the free end 12. The elongated members 10 are bolted to the base 4 by bolts 16 and nuts 18. The connector 8 has a threaded pin 20 and corresponding nut 22 to connect the attachment 2 to the trailer hitch. The elevator adjuster 6 has a rod 24 with a first screwthread 26 located on an outer surface thereof. A crank 28 having a handle 30 is removably connected to an upper end 32 of the rod 24. A support 34 extends upward from the base 4 to support a lug 36 above the base. The lug 36 has a second screwthread (not shown) formed on an inner surface thereof (not shown). The second screwthread corresponds to the first screwthread to allow the rod 24 to turn into and out of the lug 36. The support 34 is a first housing and the rod 24 is rotatably located in a second housing 38. The first and second housings 34, 38 are designed so that the first housing 34 fits within the second housing 38 and the two housings are preferably shaped so that they do not rotate relative to one another. The two housings shown have a square cross section, but various other means can be used to prevent the housings from rotating relative to one another. A sleeve 40 is located at the top of the second housing 38. The sleeve 40 maintains the rod 24 in alignment with the lug 36. The rod 24 rotates relative to the sleeve 40. The connector 8 is mounted on a front surface of the second housing 38 and a plate 42 is mounted on a rear surface of the second housing 38. The plate 42 can provide support to articles that are being transported. As the crank 28 is turned in an appropriate direction, the rod will move further into or further out of the lug 36. Since the connector 8 is at a fixed level, the movement of the rod into or out of the lug 36 will cause the base and the elongated members to move upward or downward depending on the direction in which the crank 28 is turned. Preferably, the rod and lug are an acme screw. There is a second crossmember 44 extending between the two elongated members 10. The second crossmember 44 is located near the base 4.

In FIG. 2, the same reference numerals are used to describe those components of the attachment 2 that are identical to the components shown in FIG. 1. From FIG. 2, it can be seen that there are two elongated members 10, one on either side of the base 4. The attachment 2 is connected to a trailer hitch 46, which in turn is connected to a motor vehicle (not shown), in a conventional manner. The crossmembers 14, 44 each have sleeves 48 located thereon. The crossmembers 14, 44 are threaded at each end and held in place by nuts 50 located at each end of the crossmember. Side plates 52 are located on either side of the support 34 to strengthen the base 4 and to strengthen the connection of the support 34 to the base 4.

In FIG. 3, there is shown a top view of the trailer hitch attachment 2. From the top view, it can be seen that the bolts 16 are each mounted in slots 54 extending laterally within the base 4. The slots allow the elongated members 10 to be moved closer together or further apart from one another depending on the article that is being transported by the trailer hitch attachment. The crossmembers 14, 44 are long enough to accommodate the increase in distance between the elongated members 10. The crossmembers 14, 44 are threaded at each end so that nuts 50 can be further turned on to the crossmembers, 14, 44 when it is desired to decrease the distance between the elongated members 10. The same reference numerals are used in FIG. 3 to refer to those components that are identical to the components of FIGS. 1 and 2.

In FIG. 4, there is shown a further embodiment of a trailer hitch attachment 56. The same reference numerals are used in FIG. 4 to refer to those components that are identical to the components of FIGS. 1, 2 and 3. The main difference between the trailer hitch attachment 56 shown in FIG. 4 and the trailer hitch attachment 2 shown in FIGS. 1, 2 and 3 is that the plate 42 shown in FIGS. 1, 2 and 3 is replaced by vertical bars 58 extending upward from the longitudinal members 10 near the first and second housings, 34, 38 to protect the housings from any article that is being transported by the trailer hitch attachment 56. A wheel 62 is schematically shown in FIG. 4. The wheel is the front wheel of a motorcycle 63 that is partially shown. The wheel 62 is located between the two elongated members 10 and rests on the crossmembers 14, 44. It can be seen that there are additional holes 64 located in the elongated members 10 so that the distance between the two crossmembers can be adjusted to be closer together or further apart based on the size of the article that is desired to be transported.

When the trailer hitch attachment is used to transport a motorcycle, the crank is turned to lower the elongated members to the supporting surface. The distance between the elongated members is then adjusted and, if necessary, the distance between the crossmembers is also adjusted. The front wheel of the motorcycle is then placed between the elongated members and between the two crossmembers in a manner similar to that shown in FIG. 4. The crossmembers in FIG. 4 can be moved further apart from one another so that the wheel could move downward relative to the elongated members. The crank is then rotated to move the elongated members upward from the supporting surface until the front wheel of the motorcycle is lifted above the supporting surface. The elongated members and the crossmembers are then fixed in position to snugly hold the front wheel between the elongated members. The crank is then further activated to move the elongated members further upward. Nylon (a trade mark) slings with ratcheting load binders and/or a “U” bolt or other fasteners are used to secure the motorcycle to the attachment. A rear wheel of the motorcycle (not shown) rests upon the supporting surface and rotates on the supporting surface when the towing vehicle moves to transport the motorcycle (not shown). When the destination to which the motorcycle is being moved has been reached, the bolts for the elongated members and the crossmembers are again loosened and the elongated members are moved slightly further apart to allow the front wheel to be released. The crank is then rotated to lower the elongated members to the ground and the front wheel and motorcycle are then removed from the attachment.

Articles, other than motorcycles, can also be transported using the trailer hitch attachment of the present invention. For example, a lawnmower can be transported by the attachment. The elongated members are lowered and will usually be separated by a maximum distance. The lawnmower is then moved to occupy a space above the elongated members. The lawnmower is preferably retained in position by Nylon™ slings with ratcheting load binders or other suitable fasteners. When the lawnmower is secure on the elongated members, the crank is turned to move the elongated members above or further above the supporting surface. When the elongated members are located a safe distance above the supporting surface, the crank is removed and the motor vehicle to which the attachment is affixed is operated to relocate the lawnmower. When the destination for the lawnmower is reached, the elongated members are lowered and the slings or other fasteners are removed. The lawnmower can then be rolled away from the attachment along the supporting surface. Other articles came be moved in the same manner.

I claim:

1. A trailer hitch attachment for use with a trailer hitch of a motor vehicle located on a supporting surface, said attachment comprising a base with an elevation adjuster extending upward therefrom, said elevation adjuster having a connector at a front thereof to removably connect said attachment to said trailer hitch, said base having two sides with elongated members thereon, there being one elongated member on each side, said elongated members extending rearward beyond said base, said elongated members each having a free end with a crossmember extending between said elongated members at or near said free end, said elevator adjuster being constructed to move said elongated members vertically between said supporting surface and a level sufficiently clear of said supporting surface to enable said motor vehicle to be driven when said attachment is connected to said hitch.

2. A trailer hitch attachment as claimed in claim 1 wherein said elevation adjuster and said elongated members cause said attachment to have an L-shaped profile.

3. A trailer hitch attachment as claimed in claim 1 wherein said elevation adjuster has a rod with a first screwthread thereof on an outer surface thereof, said base having a support extending upward therefrom, said support supporting a second screwthread, said second screwthread being located on an inner surface of a lug and being sized and oriented to correspond to said first screwthread, said rod having an outer end that is shaped to removably receive a crank, said elevation adjuster moving upward and downward as said rod is turned into and out of said second lug by turning said crank in an appropriate direction.

4. A trailer hitch attachment as claimed in claim 3 wherein said screwthreads form an acme screw.

5. A trailer hitch attachment as claimed in claim 4 wherein said elongated members are fixed to said base, said base having slotted openings therein to allow a distance between said elongated members to be adjusted.

6. A trailer hitch attachment as claimed in claim 1 wherein there is a second crossmember extending between said elongated members, said second crossmember being located near said base.

7. A trailer hitch attachment as claimed in claim 3 wherein said support is a first housing that supports said lug, said rod being located in a second housing, said housings being shaped so that said housings will not rotate relative to one another, said second housing having said connector on an outer surface thereof, said connector extending to said hitch.

8. A trailer hitch attachment as claimed in claim 6 wherein said connector is mounted on a front surface of said second housing and a laterally oriented plate is mounted on a rear surface of said second housing.

9. A method of transporting articles using a trailer hitch attachment for a trailer hitch of a motor vehicle, said attachment having a base with an elevation adjuster extending upward therefrom, said elevation adjuster having a connector at a front end thereof to removably connect said attachment to said trailer hitch, said base having two sides with elongated members thereon, there being one elongated member on each side, said elongated members extending rearward beyond said base, said elongated members each having a free end with a crossmember extending between said elongated members at or near said free end, said method comprising attaching said attachment to said trailer hitch, adjusting a distance between said elongated members, operating said elevation adjuster to lower said elongated members, placing an article to be transported on said elongated members, securing said article on said attachment, adjusting said elevation adjuster to raise said elongated members and said articles sufficiently above said supporting surface to allow said motor vehicle to be operated, and securing said elongated members in position.

10. A method as claimed in claim 10 including the steps of operating said elevation adjuster to lower said elongated members and release said article.

11. A method as claimed in claim 11 wherein said article is a motorcycle, adjusting a distance between said elongated members to receive a front wheel of said motor vehicle, locating a front wheel between said elongated members, re-adjusting said distance between said elongated members to hold said front wheel snugly between said elongated members and fixing said elongated members in said position, moving said elongated members upward by turning said crank on said elevation adjuster and transporting said motorcycle with a rear wheel of said motorcycle rotating on said supporting surface.

12. A method as claimed in claim 12 including the steps of activating said elevation adjuster to lower said elongated members, releasing said elongated member so that a distance between them can be varied and removing a front wheel of said motorcycle, fixing said elongated members relative to one another and activating said elevation adjuster to raise said attachment above said supporting surface to allow said motor vehicle to be driven.
